(19) United States
(12) Patent Application Publication
(10) Pub. No.: US 2016/0332680 A1
(43) Pub. Date: Nov. 17, 2016

(54) REAR SPOILER DEVICE FOR A VEHICLE

(71) Applicant: WABCO EUROPE BVBA, Brussels (BE)

(72) Inventors: Thomas Dieckmann, Pattensen (DE); David Inkermann, Braunschweig (DE); Christopher Neumann, Alfeld (DE); Gandert Marcel Rita Van Raemdonck, PW Delft (NL)

(21) Appl. No.: 15/111,024

(22) PCT Filed: Feb. 10, 2015
(86) PCT No.: PCT/EP2015/000275

§ 371 Date: Jul. 12, 2016

(30) Foreign Application Priority Data
Feb. 21, 2014 (DE) 10 2014 002 200.5
Sep. 20, 2014 (DE) 10 2014 014 215.9

(51) Int. Cl. B62D 35/00

(52) U.S. Cl. CPC B62D 35/001; B62D 35/007

(57) ABSTRACT

A rear spoiler device (8) for a vehicle (1) has at least: a roof air directing element (9) which extends in a transverse direction (y) for aerodynamically extending the contour of a roof surface (4) of the vehicle (1) in a travel position and an adjustment device (10) for adjusting the roof air directing element (9) between the travel position and a retracted basic position. The roof air directing element (9) is constructed in such a manner that in the travel position a region (9b) of the roof air directing element (9) which is external in a transverse direction (y) is located under a region (9a) of the roof air directing element (9) which is internal in a transverse direction.

### TECHNICAL FIELD

The invention relates to a rear spoiler device for a vehicle, in particular a commercial vehicle, for example, a truck, wherein the vehicle has at least one rear door, in particular two rear doors. The rear spoiler device is particularly suitable for a vehicle having a substantially box-like structure, that is to say, with side walls, roof and a rear which closes them at right-angles toward the rear and which has rear doors.

### BACKGROUND OF THE INVENTION

US 2004/0119319 A1 discloses a vehicle having such a rear spoiler device. The roof air directing elements extend the roof surface of the vehicle toward the rear and can be folded inward. Lateral air directing elements are further provided in order to extend the entire surface of the truck aerodynamically toward the rear. The adjustment device is fitted to the rear doors so that it can pivot away in the retracted state with the rear doors and releases the loading space. The fitting to the rear door produces a step between the vehicle structure and the front edge of the roof air directing elements.

In the folded-in state, however, there generally remains a bulky arrangement which projects backward, for example, as a result of the folding lines and the mechanical elements of the adjustment device. Furthermore, complete opening of the rear door through 270° toward the front for abutment against the side wall is also thereby impeded.

US 2007/0126261 A1 discloses another rear spoiler device which is fitted to the side walls of the vehicle and which allows folding in the longitudinal direction of the vehicle. This rear spoiler device also fills up the entire rear surface of the vehicle.

U.S. Pat. No. 4,682,808 B describes a rear spoiler device which is formed by a plurality of vertical and horizontal air directing elements which are fitted to different locations of the rear region. A rear spoiler device having a roof air directing element is set out as the prior art and is provided only in an internal region and fitted to the roof surface so that it extends backward over the rear region; the laterally abutting surfaces are not included by the roof air directing element. However, such air directing elements are complex to mount on the roof or the vehicle structure and generally do not allow simple opening of the rear door.

U.S. Pat. No. 7,537,270 B2 discloses a rear spoiler device having a roof air directing element and lateral air directing elements which can have different formations and which are partially provided for assembly on the rear door.

A pivotable or adjustable arrangement of air directing elements is further also disclosed, for example, in DE 10 2009 014 860 A1, DE 20 2009 014 476 U1, DE 20 2009 014 510 U1, DE 20 2009 015 009 U1 and DE 102 286 58 A1. The fitting of the air directing elements is often carried out in this instance in the hinge region so that specific hinge formations are necessary. Furthermore, the air directing elements which can be used are generally limited in terms of the length thereof, in particular when the rear door is intended to be pivoted forward through 270°. The operation and adjustment of such adjustment systems is often complex.

### SUMMARY OF THE INVENTION

An object of the invention is to provide a rear spoiler device which can be constructed with relatively little complexity and which allows secure fitting in the basic position.

Consequently, the roof air directing element is lowered or constructed in a lower position in a region which is external laterally or in a transverse direction than in laterally internal regions.

In particular, a front end or a front edge of the roof air directing element is located in a lower position on the rear door than a region which is central laterally or in the transverse direction. However, the lower external region can preferably extend over the entire length of the roof air directing element.

In the deployed travel position, the roof air directing element consequently falls away toward the laterally external region. That formation can be achieved in particular by an obliquely descending transition region; however, for example, the external region itself may also fall away outward.

Although this construction produces between the vehicle structure or the roof surface and the roof air directing element in the lateral external region a given jump or a step which may result in a given formation of turbulence, such a disadvantage is deliberately accepted according to the invention because the formation achieves substantial advantages in the shaping of the roof air directing element, in particular also in the basic position which is retracted, that is to say, pivoted down through, for example, from 70 to 90°.

The basic position is particularly achieved by planar abutment of the roof air directing element against the rear door. By the lateral outer end region being lowered in the deployed travel position, consequently, there is produced a profiling in the longitudinal direction of the vehicle in the case of planar abutment against the rear door. That profiling can, on the one hand, deliberately be selected in order to imitate structures of the rear door so that, in the basic position, a planar abutment becomes possible. This construction in particular allows a planar abutment against rear doors which have a step or projection forward in the hinge regions thereof or the region near the door pivot axis thereof. Such rear door constructions particularly also allow suitable hinge constructions in order to support a pivot operation of the door forward from the closed position through 270°. Conventional rear spoiler constructions do not allow a planar abutment against such rear spoiler constructions in this case.

The construction of the roof directing element cooperates in a particular manner synergistically with an adjustment device which not only provides for folding of the roof air directing element downward about a front pivot axis but also provides for a pivot operation with intermittent longitudinal adjustment of the roof air directing element. According to a preferred construction, there is provided for this purpose a four-bar linkage which brings about an adjustment from the retracted basic position by pivoting out toward the rear and subsequent pivoting forward of the front end of the roof air directing element against the vehicle. Consequently, such an adjustment device also allows formations of the front edge or the front end of the roof air directing element which are impossible in the case of a simple folding of the roof air directing element about a fixed pivot axis.

Such a four-bar linkage may, for example, be constructed with a large and a small rocker arm which are fitted to the rear door in a vertically offset manner, which abut the rear door in a planar manner in the basic position thereof and which are deployed toward the rear in the travel position thereof, and consequently support the roof air directing element in a suitable manner.

Consequently, it becomes possible to have a cost-effective rear spoiler device which can be constructed with little vehicle complexity and which has reliable adjustment between the basic position and the deployed position, in particular with a forced guide and suitable formation of the roof air directing element in order to also allow a planar abutment in the retracted basic position.

It is advantageously ensured in the travel position by corresponding structure that no occurrences of air turbulence which result in an increase of the air resistance of the vehicle occur between a vehicle structure and/or rear door and/or roof surface of the vehicle and the front edge of the roof air directing element. This can be achieved in a plurality of ways. On the one hand, the roof air directing element can be constructed in such a manner that the front edge thereof abuts the vehicle structure and/or rear door and/or roof surface of the vehicle in the travel position. The region between the front edge of the roof air directing element and the vehicle structure and/or rear door and/or roof surface of the vehicle is thereby sealed so that air cannot flow at all or can flow only to a very reduced extent at that location. On the other hand, a sealing element can be provided between the front edge of the roof air directing element and the vehicle structure and/or rear door and/or roof surface of the vehicle. To this end, for example, the front edge of the roof air directing element may have a sealing element, such as, for example, a sealing lip which comprises rubber or plastics material. The sealing element seals a potential gap between the front edge of the roof air directing element and the vehicle structure and/or rear door and/or roof surface of the vehicle in the travel position.

The invention is explained below with reference to the appended drawings and a number of embodiments. The drawings are provided for purely illustrative purposes and are not intended to limit the scope of the present invention.

### BRIEF DESCRIPTION OF THE DRAWINGS

In the drawings:

FIG. 1 is a perspective view of a rear region of a truck having a rear spoiler device according to a first embodiment of the invention in a travel position;

FIG. 2 is a corresponding illustration of a rear spoiler device according to a second embodiment;

FIGS. 3 to 5 show the operation of deploying the rear spoiler device from the basic position of FIG. 3 into the travel position of FIG. 5;

FIG. 6 is a rear view of the truck from FIG. 1 in a basic position;

FIG. 7 is a rear view of the truck from FIG. 1 in a travel position;

FIG. 8 is a plan view of the truck from FIG. 1 in a basic position;

FIG. 9 is a plan view of the truck from FIG. 1 in a travel position;

FIG. 10 is a side view of the truck from FIG. 1 in a travel position; and

FIG. 11 is a side view of the truck from FIG. 1 in a travel position.

### DETAILED DESCRIPTION OF THE DRAWINGS

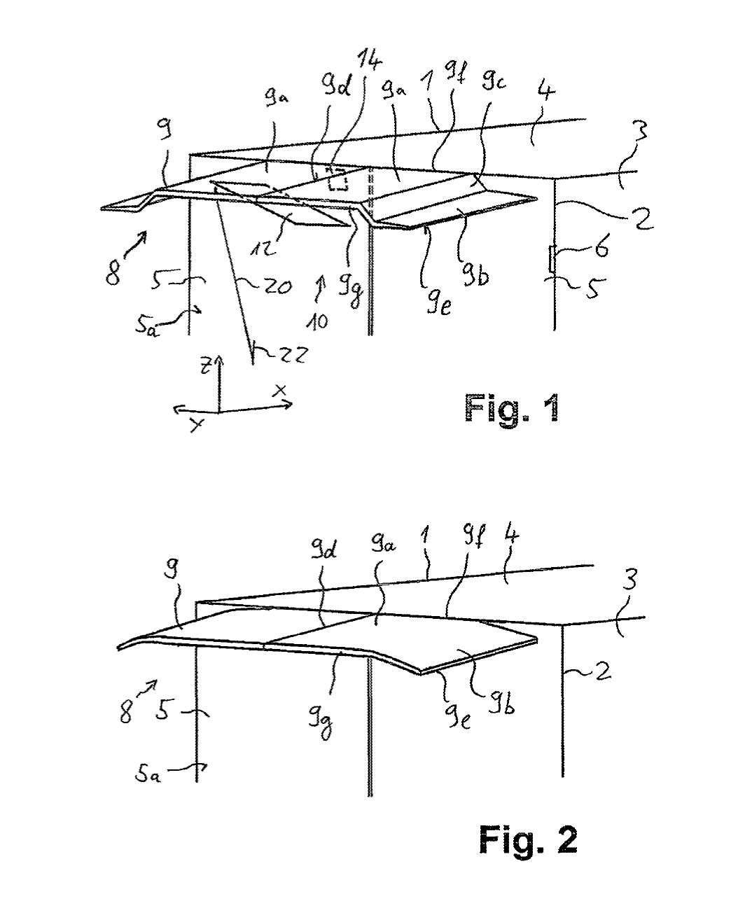

FIG. 1 shows a vehicle 1, in particular a truck 1, which has a vehicle structure 2, two side walls 3 (of which the left side wall 3 is illustrated here), a roof surface 4 and two rear doors 5 which pivot open in an outward direction. The two rear doors 5 are consequently articulated to the vehicle structure 2 in their laterally external regions or regions external in the transverse direction y by means of hinges 6 and can be pivoted open in an outward direction through approximately 270° from the closed position shown in FIGS. 1 and 2 in order to be positioned against the side walls 3 and secured or locked.

There is fitted to each rear door 5 a rear spoiler device 8 which has a roof air directing element 9 for extending the contour of the roof surface 4 toward the rear, that is to say, in the −x direction, and an adjustment device 10 for adjusting the roof air directing element 9 between the travel position shown in FIG. 1 and the basic position folded down.

The roof air directing element 9 which is produced, for example, in one piece from plastics material, is consequently used for aerodynamic contour extension of the roof surface 4, in particular with a construction falling away backward and downward; in this instance, the roof air directing element 9 may in particular be planar, but it may also have, for example, a curved extent.

The roof air directing element 9 has an internal region 9a which directly adjoins the roof surface 4 or the vehicle structure 2 which receives the roof surface 4 toward the rear, and which subsequently falls away toward the rear. Furthermore, the roof air directing element 9 has a laterally external region 9b or region 9b which is external in the transverse direction y and which is lower in the travel position than the internal region 9a, that is to say, is offset and/or falls away downward in a vertical direction (−z direction).

Consequently, an inner edge 9d which extends in the x direction is also higher (above in the z direction) than an outer edge 9e in the transverse direction.

According to the embodiment of FIG. 1, a transition region 9c which falls away outward obliquely in the transverse direction is constructed between the internal region 9a and the external region 9b; according to the alternative embodiment of FIG. 2, the external region 9b directly adjoins the internal regions 9a and falls away outward obliquely in a transverse direction y.

The lower external region 9b may extend in particular over the entire longitudinal direction, that is to say, the x direction.

Although this construction of the roof air directing element produces in the laterally external region 9b a small jump from the roof surface 4 or the vehicle structure 2 to the rear door 5, and it is recognized that the break-away edge thereby produced can result in a slight worsening or increase of the air resistance, however, it has been found that the impairment is fairly small and in any case a formation of turbulence also occurs near the side faces 3 in the region of the upper edge or the rear region between the roof surface 4, side wall 3 and rear door 5. In particular, as a result of the laterally external lowering of the roof air directing element 9, a planar abutment in the basic position becomes possible; consequently, it is possible to have a great freedom of shaping of the rear doors 5 in the laterally external region. Additional advantages result in the folded-in basic position which will be explained below with reference to the adjustment device 10.

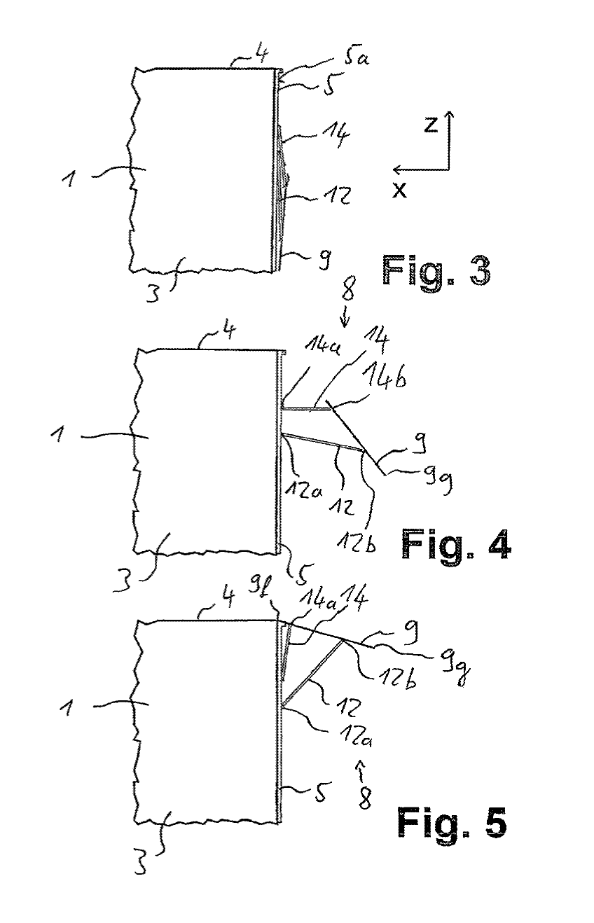

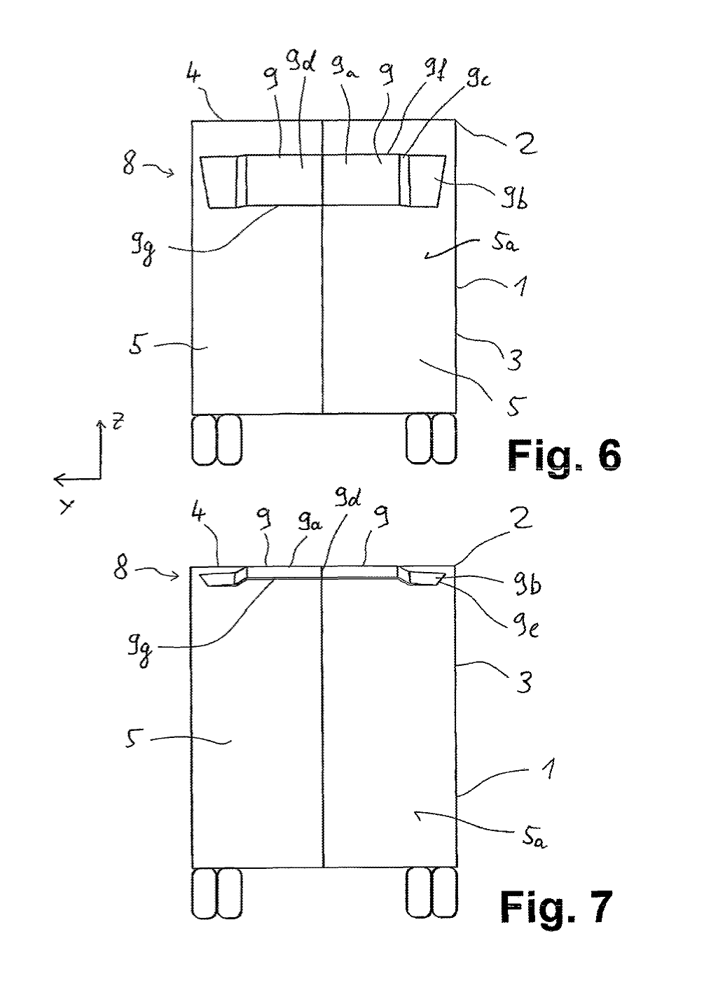

According to the construction shown, the adjustment device 10 is provided so as to have a large rocker arm 12 and at least one small rocker arm 14 which are each articulated between the rear door 5 and the roof air directing element 9. In this instance, according to FIG. 4, the large rocker arm 12 is articulated in a front link 12a to the rear door 5 and in a rear link 12b to the roof air directing element 9; accordingly, the small rocker arm 14 is articulated in a front link 14a to the rear door 5 and a rear link 14b to the roof air directing element 9. Advantageously, the connection of the entire rear spoiler device 8, that is to say, the roof air directing element 9 together with the adjustment device 10, is brought about only at the outer face 5a of the rear door 5 by suitable connection plates, in which the front links 12a and 14a are constructed, being fixed to the outer side 5a. Consequently, in principle, any vehicles 1 having corresponding rear doors 5 can be provided with the rear spoiler device 8; a connection, for example, to an upper edge of the rear door 5 is unnecessary. Furthermore, it is not necessary to fix the rear spoiler device 8 to the vehicle structure 2, the roof surface 4 or the side wall 3.

According to FIGS. 3 to 5, a pivot path of the roof air directing element 9 becomes possible as a result of the four-bar linkage with front links 12a and 14a which are offset in a vertical direction z relative to each other, wherein the roof air directing element 9 is positioned in a planar manner on the rear door 3 in the basic position of FIG. 3, wherein it is advantageously positioned on the rocker arms 12 and 14 which are also positioned in a planar manner on the rear door 5. Consequently, a planar construction is produced in the basic position of FIG. 3; the rear door 5 can consequently be pivoted forward through 270° after opening and be locked to the side wall 3. The installation is advantageously carried out according to FIGS. 4 and 5 by means of an actuation rod 20 which can be seen in FIG. 1 and which can be fixed in a securing member 22 to the rear door 5 both in the planar position thereof and in the deployed travel position of FIGS. 1 and 5. The roof air directing element 9 consequently pivots out from the basic position of FIG. 3 initially both with the front edge 9f thereof and the rear edge 9g in a backward direction, that is to say, in the −x direction, and subsequently according to the transition from FIG. 4 to FIG. 5 with the front edge 9f thereof forward or in the x direction so that the front edge 9f moves forward from the rear against the vehicle structure 2 or the rear door 5.

That pivot mechanism consequently facilitates the adjustment of the roof air directing element 9 with the lowered external region 9b; unlike in, for example, simple folding operations about a fixed pivot axis which is provided on the front edge of the roof air directing element, the precise shaping of the front edge 9f is not problematic for the pivoting operation of the adjustment device 10.

It is further possible to have a simple adjustment and planar abutment in the basic position; it is simply necessary for the actuation rod 20 to be gripped and guided upward so that subsequently, as a result of the four-bar linkage, a forced guiding is brought about without degrees of freedom which are disruptive for the users or a “fluttering” of the adjustment system. In the basic position of FIG. 3, the roof air directing element 9 can consequently abut the rear door 5 in a planar manner; the shaping with the lateral lowering, that is to say, the external region 9b, can be adapted to a shaping of the rear door 5 in this case. Consequently, it is in particular also possible for the roof air directing element 9 to abut in a planar manner a rear door 5, the outer side 5a of which is recessed in the laterally external region thereof near the hinges, that is to say, it extends further forward in the x direction.

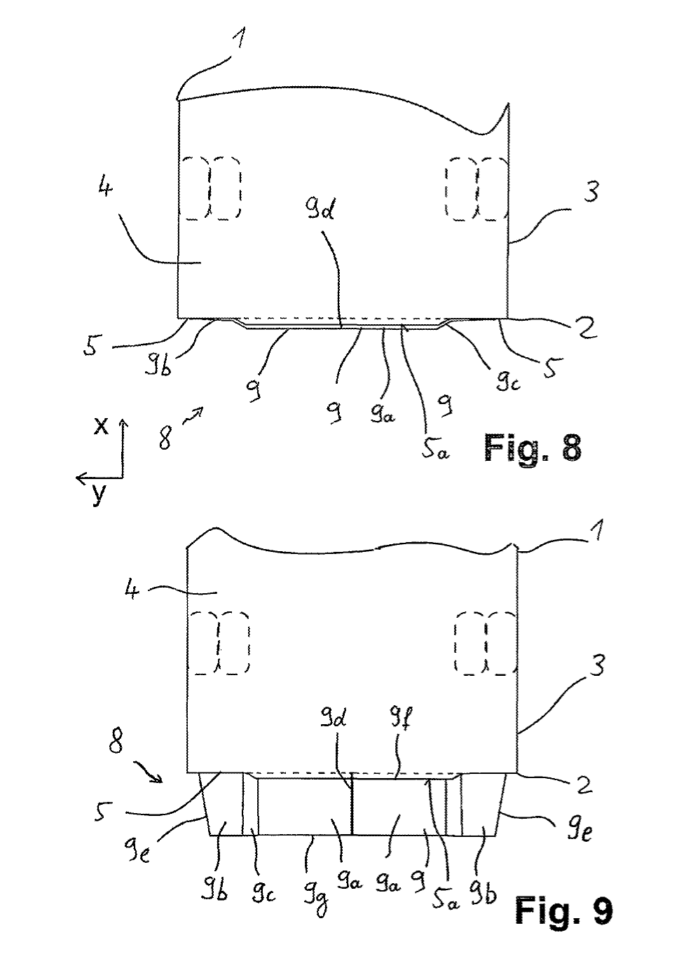

Such a construction is particularly evident from the plan views of FIGS. 8 and 9. Consequently, the roof air directing element 9 can also abut the rear door 5 in a planar manner in the case of such profiling of the vehicle structure 7 and the rear door 5 in the basic position of FIG. 8. As a result of such a construction of the rear region of the truck 1, the hinge 6 can be offset slightly forward with respect to the rear door 5 so that the pivot operation through 270° for opening the rear door 5 is improved. The roof air directing element 9 can be adapted to such a shaping.

The left-hand and right-hand rear spoiler devices 8 are constructed in an identical manner, with roof air directing elements 9 which are constructed, for example, in a mirror-symmetrical manner relative to each other; the rocker arms 12 and 14 can be constructed identically at the left and right.

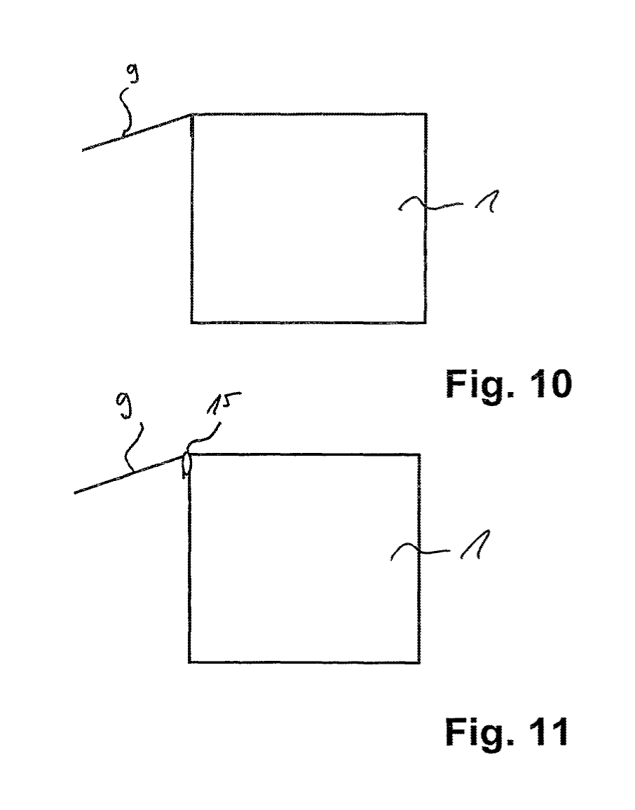

It is advantageously ensured in the travel position by corresponding structure that no occurrences of air turbulence which result in an increase of the air resistance of the vehicle occur between a vehicle structure and/or rear door and/or roof surface of the vehicle and the front edge of the roof air directing element. This can be achieved in a plurality of ways. FIG. 10 which is a side view of the truck from FIG. 1 in the travel position illustrates a method in which the roof air directing element (9) is constructed in such a manner that the front edge (9f) thereof in the travel position abuts the vehicle structure (2) and/or rear door (5) and/or roof surface (4) of the vehicle (1). The region between the front edge (9f) of the roof air directing element (9) and the vehicle structure (2) and/or rear door (5) and/or roof surface (4) of the vehicle (1) is thereby sealed so that air cannot flow at all or can flow only to a very reduced extent at that location. On the other hand, a sealing element can be provided between the front edge (9f) of the roof air directing element (9) and the vehicle structure (2) and/or rear door (5) and/or roof surface (4) of the vehicle (1). To this end, for example, the front edge (9f) of the roof air directing element (9) may have a sealing element (15), such as, for example, a sealing lip which comprises rubber or plastics material. The sealing element (15) seals a potential gap between the front edge (9f) of the roof air directing element (9) and the vehicle structure (2) and/or rear door (5) and/or roof surface (4) of the vehicle (1) in the travel position.

While the above description constitutes the preferred embodiments of the present invention, it will be appreciated that the invention is susceptible to modification, variation and change without departing from the proper scope and fair meaning of the accompanying claims.

1. A rear spoiler device (8) for a vehicle (1), wherein the rear spoiler device (8) has at least:
a roof air directing element (9) which extends in a transverse direction (y) for aerodynamically extending a contour of a roof surface (4) of the vehicle (1) in a travel position and
an adjustment device (10) for adjusting the roof air directing element (9) between the travel position and a retracted basic position,
wherein the roof air directing element (9) is constructed in such a manner that in the travel position a laterally outer region (9b) of the roof air directing element (9) in a transverse direction (y) is positioned lower than laterally central region (9a) of the roof air directing element (9).

2. The rear spoiler device (8) as claimed in claim 1, wherein in the travel position an inner edge (9d) of the roof air directing element (9), which inner edge extends in a longitudinal direction (x) and closes the roof air directing element (9) in an inward direction, is higher than an outer edge (9e) of the roof air directing element (9), which outer edge extends in a longitudinal direction (x) and closes the roof air directing element (9) in an outward direction.

3. The rear spoiler device (8) as claimed in claim 1, wherein the lower laterally outer region (9b) extends as far as a front edge (9f) of the roof air directing element (9), wherein the front edge (9f) is provided for abutment against at least one of the following vehicle parts: a vehicle structure (2), a rear door (5), or a roof surface (4) of the vehicle (1) in the travel position.

4. The rear spoiler device (8) as claimed in claim 3, wherein the lower laterally outer region (9b) extends over the entire roof air directing element (9) from the front edge (9f) thereof as far as the rear edge (9g) thereof.

5. The rear spoiler device (8) as claimed in claim 1, wherein the roof air directing element (9) has an obliquely descending transition region (9c) between the laterally outer region (9b) and the laterally central region (9a).

6. The rear spoiler device (8) as claimed in claim 1, wherein the laterally central region (9a) and the laterally outer region (9b) each extend substantially parallel and, in the basic position, vertically.

7. The rear spoiler device (8) as claimed in claim 1, wherein both the laterally central region (9a) and the laterally outer region (9b) of the roof air directing element (9) in the basic position abut a correspondingly formed outer side (5a) of a rear door (5) in a planar manner.

8. The rear spoiler device (8) as claimed in claim 1, wherein it is configured to can be fitted completely to a rear door (5) or a pair of rear doors (5) of the vehicle (1).

9. The rear spoiler device (8) as claimed in claim 8, wherein it is configured to be received in the basic position thereof between the rear door (5) and the side wall (3) when the rear door (5) is pivoted forward and can be secured to a side wall (3).

10. The rear spoiler device (8) as claimed in claim 1, wherein the adjustment device (10) is constructed as a forced guide having only one degree of freedom for adjusting the roof air directing element (9) between the basic position and the travel position.

11. The rear spoiler device (8) as claimed in claim 10, wherein the adjustment device (10) is constructed as a four-bar linkage having four links or articulation axes (12a, 12b, 14a, 14b), at least one large rocker arm (12) having a greater length (L1, L3) and at least one smaller rocker arm (14) having a smaller length (L2, L4) that is shorter than the greater length of the at least one large rocker arm, wherein the large rocker arm (12) and the small rocker arm (14) each have a front link (12a, 14a) for connection to a rear door (5) of the vehicle (1) and a rear link (12b, 14b) for connection to the roof air directing element (9).

12. The rear spoiler device (8) as claimed in claim 11, wherein the front link (14a) of the small rocker arm (14) is configured to be connected to the rear door (5) in a transverse direction (y) at a higher position in a vertical direction in the direction toward the roof surface (3) of the vehicle (1) than the front link (12a) of the large rocker arm (12).

13. The rear spoiler device (8) as claimed in claim 11, wherein the rear link (14b) of the small rocker arm (14) is connected closer to a front edge (9f) of the roof air directing element (9) than the rear link (12b) of the large rocker arm (12).

14. The rear spoiler device (8) as claimed in claim 11, wherein the roof air directing element (9) is positioned in the basic position in a planar manner on the small rocker arm (14) and on the large rocker arm (12) substantially parallel to the rear door (5).

15. The rear spoiler device (8) as claimed in claim 1, further comprising a sealing element (15) between a front edge (9f) of the roof air directing element (9) and at least one of the following vehicle parts: a vehicle structure (2), a rear door (5), or a roof surface (4) of the vehicle (1).

16. The rear spoiler device (8) as claimed in claim 15, wherein the front edge (9f) of the roof air directing element (9) has the sealing element (15).

17. The rear spoiler device (8) as claimed in claim 15, wherein the sealing element (15) comprises a rubber material or a plastics material.

18. The rear spoiler device (8) as claimed in claim 1, wherein the front edge of the roof air directing element (9) abuts, in the travel position, at least one of the following vehicle parts: a vehicle structure (2), a rear door (5), or a roof surface (4) of the vehicle (1).

19. The rear spoiler device (8) as claimed in claim 17, wherein the sealing element comprises a fiber-reinforced rubber or plastics material.
